(19) United States
(12) Patent Application Publication
(10) Pub. No.: US 2008/0043978 A1
(43) Pub. Date: Feb. 21, 2008

(54) Network telephone system for recovering talk after unexpected disconnection and method thereof

(75) Inventors: Sun-Loi Lai, Penang (MY); Chia-Hwa Lee, Taipei (TW)

Correspondence Address: REED SMITH LLP;Suite 1400, 3110 Fairview Park Drive, Falls Church, VA, 22042, US

(73) Assignee: Inventec Multimedia & Telecom Corporation.

(21) Appl. No.: 11/494,487

(22) Filed: Jul. 28, 2006

(51) Int. Cl. H04M 7/00

(52) U.S. Cl. 379/221.04

(57) ABSTRACT

A network telephone system for recovering talk after an unexpected disconnection and a method thereof are used to recover an unexpectedly disconnected talk between network telephones. The network telephone system includes a central processing unit, a talk database, a real-time transport protocol (RTP) buffer, and a network module. A method for recovering talk after an unexpected disconnection includes: recording and storing information of the network telephone in a talk state; judging whether an unexpected disconnection of talk occurs by checking that the network is disconnected or no RTP packet exists; and re-establishing talk by inquiring the network telephone information of a current talk.

### BACKGROUND OF THE INVENTION

1. Field of Invention

The present invention relates to a system for controlling talk in network telephone communication and a method thereof, and more particularly to a network telephone system for recovering talk after an unexpected disconnection and a method thereof.

2. Related Art

Currently, with increasingly widespread network construction, the communication industry is developing quickly. Ordinary home users can afford adequate bandwidth at low prices, and due to progress in speech technology, various network telephone services can provide stable talk quality. Therefore, the network telephone has become a concept acceptable to the masses. It has become a trend in the new era that more and more computer users talk with friends at remote terminals via network telephones without paying expensive call fees.

Generally, the network telephone provides the functions of call hold and call transfer. When using a call hold service, both the user and his counterpart are still in a talk state but temporarily cannot hear each other. At this moment, the user can make another network telephone call, or get another network telephone call. After finishing the call, the user can continue talking with the previously held party. The call transfer can automatically or manually transfer a current call to another network telephone number.

Korea Pat. No. KR9512310 issued on Oct. 16, 1995 provides a system for recovering a call and a method thereof. However, the system and method only emphasizes the procedures of temporarily suspending a call and recovering the call afterward.

However, in the middle of a talk, an unexpected disconnection is caused by a network failure or other accidents, the network telephone system of the prior art cannot automatically recover the previous talk state, thereby resulting in inconvenience and trouble for the user.

### SUMMARY OF THE INVENTION

To solve the above problems in the prior art, the object of the present invention is to provide a network telephone system for automatically recovering talk after an unexpected disconnection and a method thereof.

A network telephone system provided by the present invention comprises a central processing unit (CPU) for recording network telephone information, detecting whether a talk is unexpectedly disconnected, and recovering the talk; a talk database for storing the network telephone information; a real-time transport protocol (RTP) buffer used for storing the RTP packets is provided for the CPU to judge whether the talk is unexpectedly disconnected; and a network module for transmitting and receiving the RTP packet and provided for the CPU to judge whether a talk is unexpectedly disconnected.

The CPU further comprises: a talk data recording module for recording the information of the network telephone in a talk state; an unexpected disconnection detecting module for judging whether an unexpected disconnection has occurred by the RTP buffer and the network module; and a disconnected talk recovering module for recovering the unexpectedly disconnected talk by obtaining the network telephone information of a current talk via inquiring the talk database.

A method for recovering talk after an unexpected disconnection provided by the present invention comprises: recording and storing the information of the network telephone in a talk state; judging whether an unexpected disconnection of the talk has occurred by checking whether a network is disconnected or no existing RTP packet; and inquiring the talk database to obtain the network telephone information of a current talk then re-establishing the talk.

In view of the above, the present invention has the following advantages:

1. After a talk between the two parties of a network telephone is suddenly disconnected due to problems in network connection, excessive network flow, or other unpredictable causes, the system will automatically recover the talk on the judgment that the talk is unexpectedly disconnected by detecting that neither of the two parties has sent a farewell message as a normal ending to the talk.

2. The present invention utilizes the talk database of the system to inquire the network telephone information of a current talk, obtain the telephone number and internet protocol address of the called party, and re-establish the talk between the parties.

### BRIEF DESCRIPTION OF THE DRAWINGS

The present invention will become more fully understood from the detailed description given herein below for illustration only, and which thus is not limitative of the present invention, and wherein:

FIG. 1a is a block diagram of a normally-ended talk of the network telephone of the present invention;

FIG. 1b is a block diagram of an unexpectedly-ended talk of the network telephone of the present invention;

FIG. 2 is a schematic view of the message flow of starting a talk according to a session initiation protocol (SIP);

FIG. 3 is a schematic view of the message flow of recovering a talk according to the SIP;

FIG. 4 is a schematic structural view of a talk database;

FIG. 5 is a block diagram of the network telephone system according to the present invention, wherein a talk is recovered after an unexpected disconnection;

FIG. 6 is a flow chart of the procedure for recording the network telephone information;

FIG. 7 is a flow chart of the procedure for detecting an unexpected disconnection; and

FIG. 8 is a flow chart of the procedure for recovering a disconnected talk.

### DETAILED DESCRIPTION OF THE INVENTION

In the following part, preferred embodiments of the present invention will be illustrated in detail with the accompanying drawings.

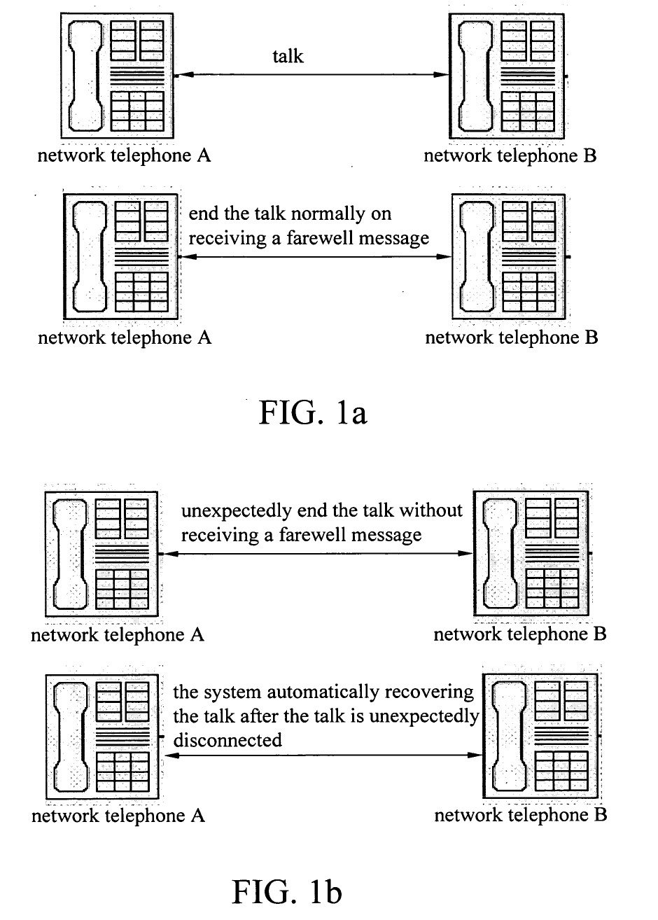

Please refer to FIGS. 1a and 1b. FIG. 1a is a block diagram of a normally-ended talk of the network telephone of the present invention. FIG. 1b is a block diagram of an unexpectedly-ended talk of the network telephone of the present invention. As shown in FIG. 1a, if a farewell message is received in the process of the talk, the talk is thus ended normally. As shown in FIG. 1b, if no farewell message is received in the process of a talk, the talk is unexpectedly disconnected, and the system will automatically recover the connection to continue the previous talk.

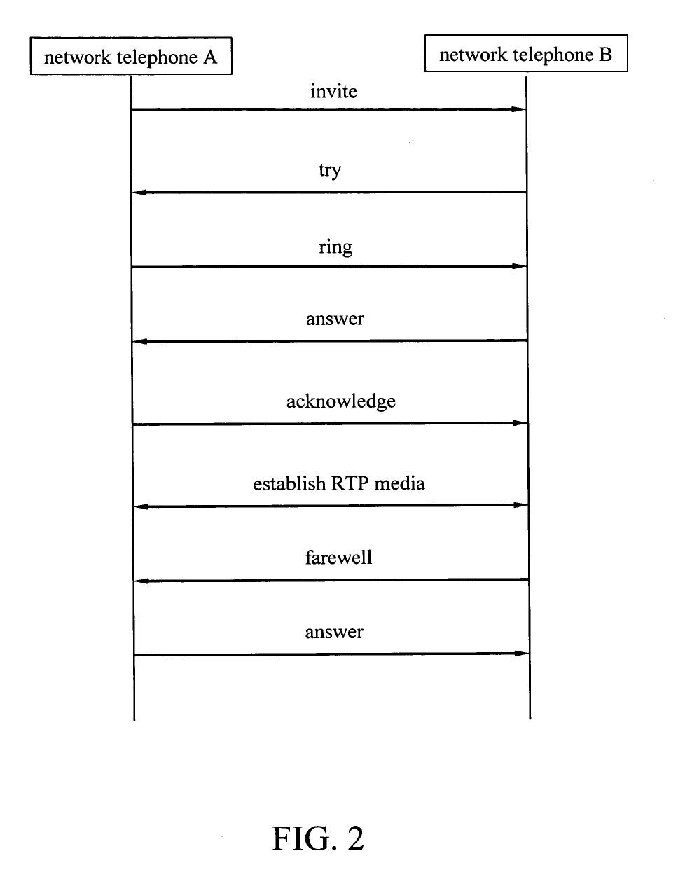

Please refer to FIG. 2 of a schematic view of the message flow of starting a talk according to an SIP, showing a normal message flow between network telephones A and B from starting to ending the talk. As shown in FIG. 2, when the network telephone A tries to call the network telephone B, the network telephone A sends an invite message to the network telephone B. After receiving the message, the network telephone B feeds back a trial message as a response. After that, the network telephone A sends a ringing request, and the network telephone B thus begins to ring and send an answer message to the network telephone A. The network telephone A then sends an acknowledge message to the network telephone B on receiving the answer message. At this moment, both parties talk by exchanging RTP packets. If intending to hang up the telephone, the network telephone B then sends a farewell message to the network telephone A. After receiving the farewell message, the network telephone A sends an answer message as a response, and then the talk is ended normally.

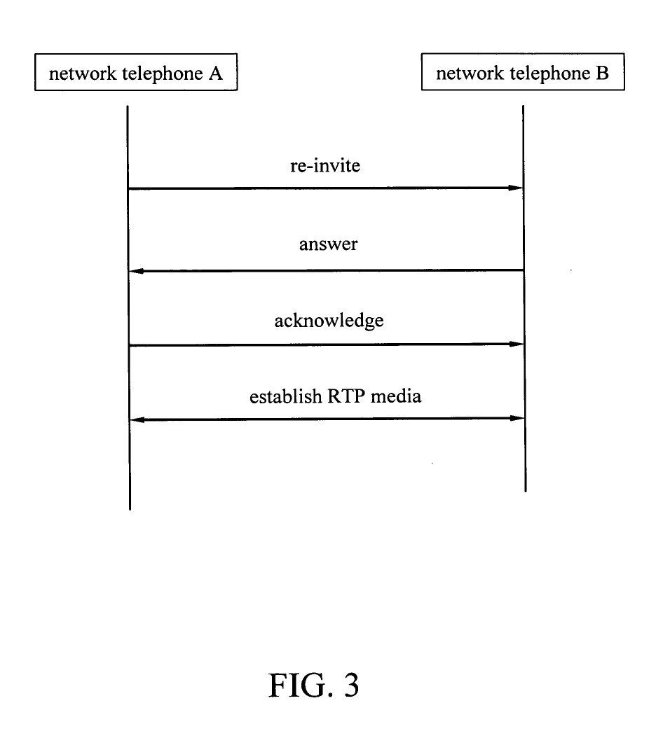

Please refer to FIG. 3 of a schematic view of the message flow of recovering a talk according to an SIP, showing the message flow for the network telephone A to try to recover the previous unexpectedly disconnected talk. As shown in FIG. 3, the network telephone A sends a re-invite message to the network telephone B. The network telephone B then returns an answer message on receiving the message. After that, the network A sends an acknowledge message to the network telephone B. At this moment, both parties can talk by exchanging RTP packets. Compared with the process of normally establishing a talk, the procedure of recovering a talk requires neither a trial nor a ring message, and thus has a relatively simple message flow.

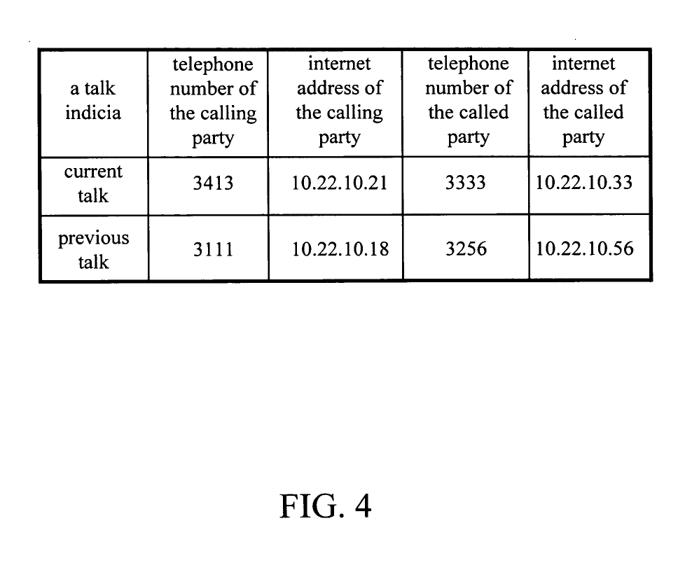

Please refer to FIG. 4 of a schematic structural view of a talk database for storing the information of both parties of a talk of the network telephone. While a talk is successfully established, both the network telephone number and the internet protocol address are recorded in the talk database. The network telephone information of an ongoing talk is then marked with a currently-connected tag. When the talk is unexpectedly ended, the system searches the talk database, and identifies the related information of the unexpectedly disconnected network telephone by inquiring the network telephone information with a currently-connected tag. And then, the system sends a re-invite message to the called party of the network telephone to recover the talk between the two parties.

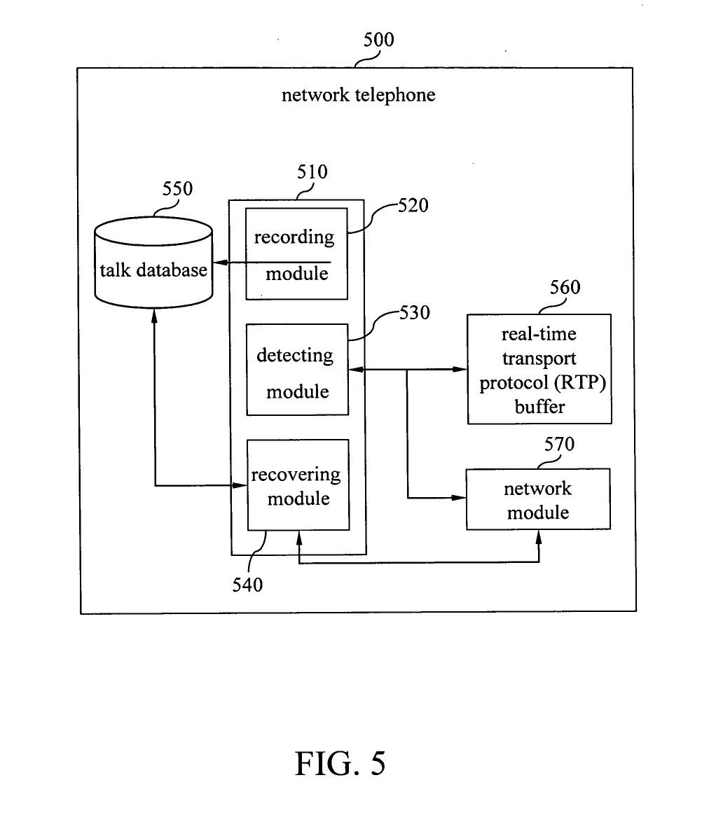

Please refer to FIG. 5 of a block diagram of the network telephone system of the present invention, wherein a talk is recovered after being unexpectedly disconnected. As shown in FIG. 5, the network telephone system 500 of the invention comprises a CPU 510, a talk database 550, an RTP buffer 560, and a network module 570. The CPU 510 is used for recording the network telephone information, detecting whether the talk is unexpectedly disconnected, and recovering the talk. The talk database 550 is used for storing the information of the network telephone in a talk state. The RTP buffer 560 functions as a temporary storage space for storing the RTP packets containing speech data, the RTP packets are provided for the CPU 510 to judge whether the talk is unexpectedly disconnected. The network module 570 is used for transmitting and receiving the RTP packet during the talk of the network telephone, and is provided for the CPU 510 to judge whether the talk is unexpectedly disconnected.

The CPU 510 further includes a recording module 520 for recording data of the called party, a detecting module 530 for detecting unexpected disconnections, and a recovering module 540 for recovering a disconnected talk. The recording module 520 manages the recording procedure, i.e., recording the information of the network telephone in a talk state. The detecting module 530 manages the procedure for detecting the unexpected disconnections, i.e., identifying unexpected disconnections by detecting the RTP buffer 560 and the network module 570. The recovering module 540 manages the procedure for recovering talk, i.e., obtaining the network telephone information of the current talk by inquiring the talk database 550 and sending a re-invite message to recover the unexpectedly-ended talk between the two parties of the network telephone.

The method for recovering an unexpectedly disconnected talk according to the present invention is first to utilize the recording module 520 to record and store the information of the network telephone in a talk state and set a currently-connected tag. Then, the detecting module 530 judges whether the talk is unexpectedly disconnected by checking the network connecting state and checking the existence of an RTP packet and then sets a disconnection cause tag corresponding to the disconnection cause. Finally, the recovering module 540 re-establishes the talk by inquiring the network telephone information of the current talk in accordance with the disconnection cause tag.

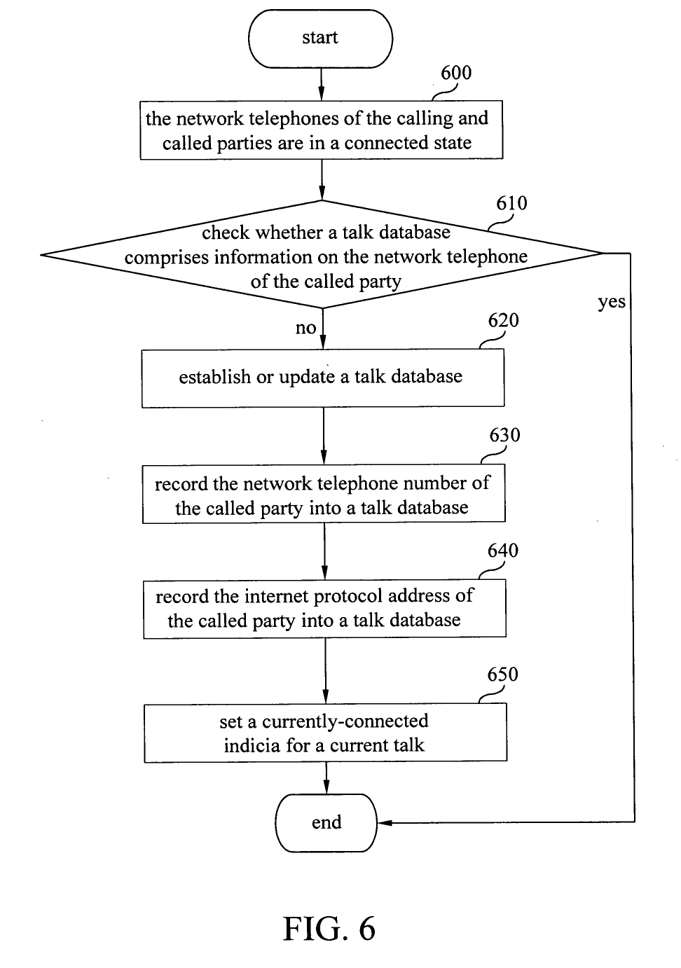

Please refer to FIG. 6 of a flow chart of the procedure for recording the network telephone information. If both the network telephones of the calling party and of the called party are in a connected state (Step 600), the system checks whether the talk database 550 contains the network telephone information of the called party (Step 610). If the network telephone information of the called party exists in the talk database 550, this procedure is then ended. If no network telephone information of the called party exists in the talk database 550, the network telephone of the calling party then establishes or updates the talk database 550 (Step 620). The network telephone of the calling party records the network telephone number of the called party in the talk database 550, thereby completing an adding process of the database (Step 630). Besides the network telephone number, the internet protocol address of the called party is also recorded in the talk database 550 (Step 640). The system regards the information of the network telephone in a talk state as a currently-connected talk, and sets a currently-connected tag (Step 650). The information of the currently-connected talk is used afterward in the procedure for recovering the talk.

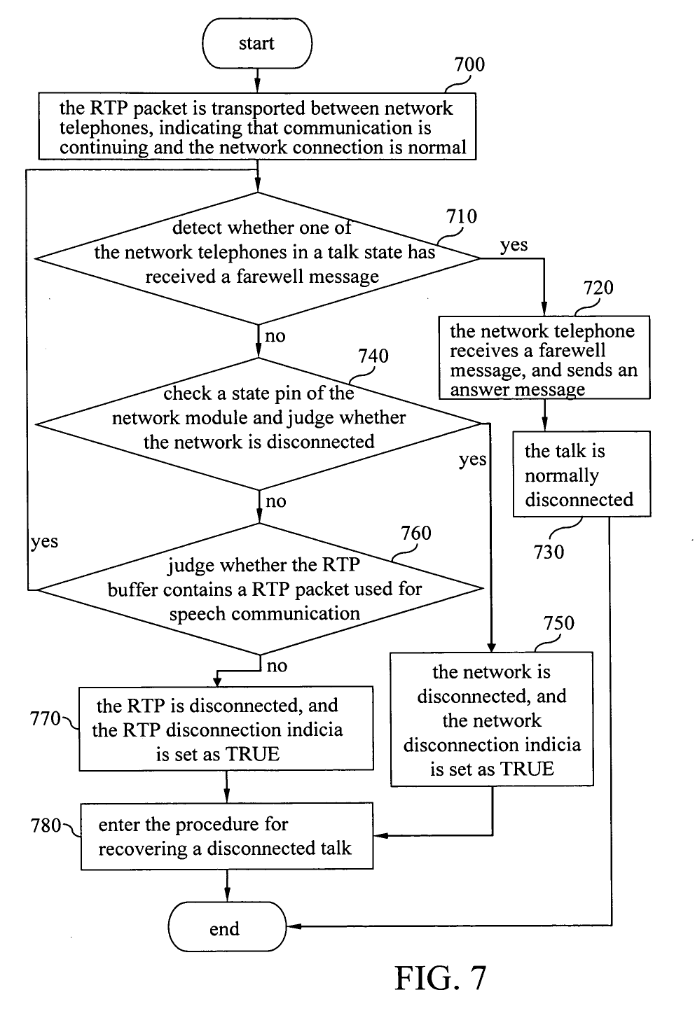

Please refer to FIG. 7 of a flow chart of the procedure for detecting unexpected disconnections. If the RTP packet is transmitted between the network telephones during the talk, it indicates that the communication is continuing and the network connection is normal (Step 700). During the period that the network is in a connected state, the system regularly detects whether one of the network telephones in a talk state has received a farewell message (Step 710). If one of the network telephones has received the farewell message, an answer message is then sent (Step 720), indicating that the talk is disconnected normally (Step 730), and the procedure is ended. If no farewell message is detected, the system must judge whether the network has been disconnected, wherein the network connecting state can be judged by checking the high-and-low state of a state pin of the network module 570 (Step 740). If the checking result indicates that the network is now in a disconnected state, a network disconnection tag is set as TRUE denoting that the network has been disconnected (Step 750). However, if the network connection is in a normal state, the system judges whether the RTP buffer 560 comprises the RTP packet used for speech communication (Step 760). If the RTP buffer 560 comprises the RTP packet used for speech communication, the system returns to continuing judging whether a farewell message has been received. If the RTP buffer 560 comprises no RTP packet used for speech communication, the system sets the RTP disconnection tag as TRUE denoting that the RTP has been disconnected (Step 770). As for both disconnecting situations, the system enters the procedure for recovering the disconnected talk (Step 780).

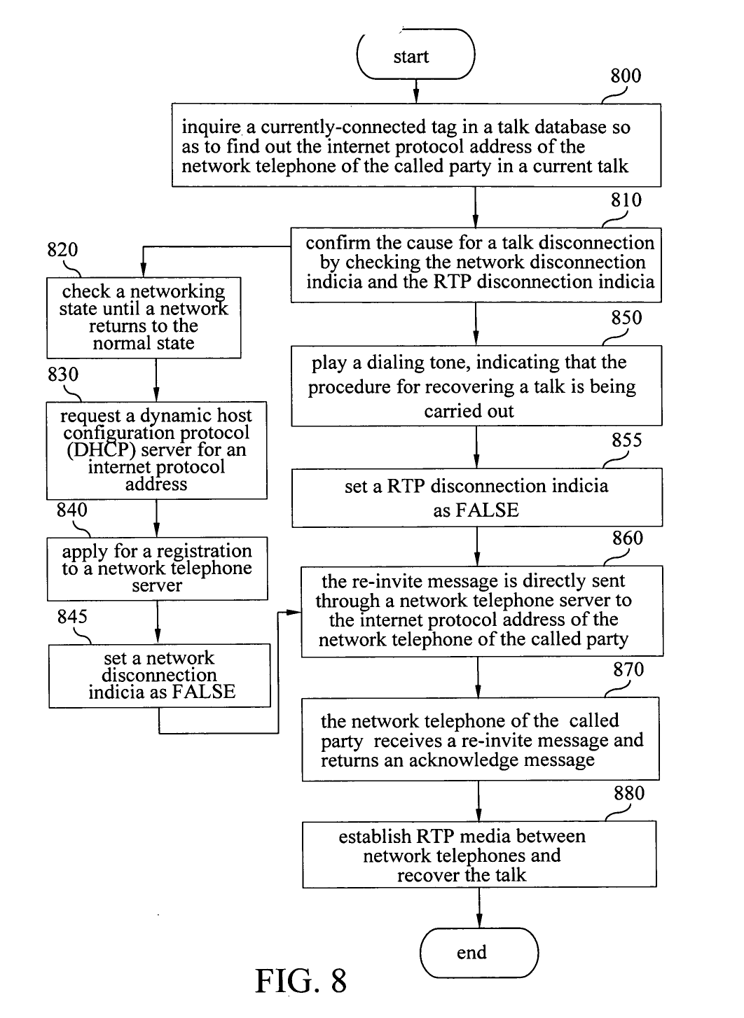

Please refer to FIG. 8 of a flow chart of the procedure for recovering the talk. During the period of recovering a disconnected talk, the system first inquires the currently-connected tag in the talk database 550 so as to find out the internet protocol address of the network telephone of the called party in the current talk (Step 800). Then the system checks the network disconnection tag and the RTP disconnection tag to confirm the cause of the talk disconnection (Step 810). If the talk disconnection is caused by the network disconnection, the system checks the network connecting state by checking the state pin of the network module 570 until the network returns to a normal state (Step 820). Once the network returns to a normal state, the network telephone of the calling party requests a dynamic host configuration protocol (DHCP) server for the internet protocol address (Step 830), and again applies for a registration to the network telephone server (Step 840). After that, the system sets a network disconnection tag as FALSE (Step 845). Then, the talk steps are re-established. A re-invite message is directly sent by the network telephone through the network telephone server to the internet protocol address of the network telephone of the called party (Step 860). After receiving the re-invite message, the network telephone of the called party returns an acknowledge message (Step 870). At this moment, RTP media are re-established between the network telephones, and the previous talk begins to be recovered between the network telephones (Step 880). If the disconnection of the RTP results in a network disconnection, the system plays a dialing tone indicating that the procedure for recovering the talk is being carried out to inform the user that the system is implementing the procedure for recovering the talk (Step 850). And then, the system sets the RTP disconnection tag as FALSE (Step 855). After that, the talk begins to be re-established, and a re-invite message is directly sent by the network telephone through the network telephone server to the internet protocol address of the network telephone of the called party (Step 860). After receiving the re-invite message, the network telephone of the called party returns an acknowledge message (Step 870). At this moment, RTP media are re-established between the network telephones, and the previous talk begins to be recovered between the network telephones (Step 880).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network telephone system, comprising:
a central processing unit (CPU) for recording network telephone information, detecting whether a talk is unexpectedly disconnected, and recovering the talk;
a talk database for storing the network telephone information;
a real-time transport protocol (RTP) buffer for storing a plurality of RTP packets, provided for the CPU to judge whether an unexpected disconnection of the talk has occurred; and
a network module for transmitting and receiving the RTP packets, and enabling the CPU to judge whether an unexpected disconnection of the talk has occurred.

2. The network telephone system as claimed in claim 1, wherein the CPU further comprises:
a recording module for recording information of the network telephone in a talk state;
an detecting module for judging whether an unexpected disconnection has occurred by detecting the RTP buffer and the network module; and
a recovering module for recovering an unexpectedly disconnected talk by obtaining the network telephone information of a current talk via inquiring the talk database.

3. The network telephone system as claimed in claim 1, wherein the network telephone information further comprises a plurality of telephone numbers and internet protocol addresses which belong to the network telephones of the calling and called parties.

4. The network telephone system as claimed in claim 1, wherein the talk database further comprises a currently-connected tag used for the disconnected talk recovering module to inquire the current talk.

5. A method for recovering a talk after an unexpected disconnection for recovering a talk after an unexpected disconnection of the network telephone, the method comprising:
recording and storing network telephone information in a talk state;
judging whether an unexpected disconnection of the talk has occurred by checking whether a network is disconnected or no RTP packet exists, and setting a disconnection cause tag corresponding to a disconnection cause; and
re-establishing talk by inquiring the network telephone information of the current talk according to the disconnection cause tag.

6. The method for recovering a talk after an unexpected disconnection as claimed in claim 5, wherein the step of re-establishing talk further comprises:
sending a re-invite message from the calling party to the called party;
returning an answer message by the called party; and
sending an acknowledge message from the calling party to the called party to start recovering talk.

7. The method for recovering a talk after an unexpected disconnection as claimed in claim 5, wherein the step of recording the network telephone information further comprises recording a plurality of telephone numbers and internet protocol addresses which belong to the network telephones of the calling and called parties.

8. The method for recovering a talk after an unexpected disconnection as claimed in claim 5, wherein the step of recording the network telephone information further comprises setting a currently-connected tag for recovering talk after the unexpected disconnection.

9. The method for recovering a talk after an unexpected disconnection as claimed in claim 5, wherein the disconnection cause tag comprises a network disconnection tag or an RTP packet disconnection tag.
